(19) United States
(12) Patent Application Publication
(10) Pub. No.: US 2009/0300207 A1
(43) Pub. Date: Dec. 3, 2009

(54) PCC ENHANCEMENTS FOR CIPHERING SUPPORT

(75) Inventors: Gerardo Giaretta, San Diego, CA (US); Kalle Ahmavaara, San Diego, CA (US); Lorenzo Casaccia, Rome (IT); Georgios Tsirtsis, London (GB)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/476,050

(22) Filed: Jun. 1, 2009

Related U.S. Application Data
(60) Provisional application No. 61/057,968, filed on Jun. 2, 2008.

(51) Int. Cl. G06F 15/16; H04L 9/00

(52) U.S. Cl. 709/232; 713/150; 709/230

(57) ABSTRACT

Systems and methodologies are described that facilitate tunneling within wireless communication systems. Flow identification information is dynamically generated for data flows within a communication system. This flow identification information assists in determining appropriate flow specific policies to be applied with respective data flows. The flow identification information along with the flow specific policies can be communicated to an access mechanism which transmits the data flows in accordance with the flow specific policies. Different aspects relate to using source addresses in combination with the flow identification information for identifying different IP flows originating at a plurality of sources. The flow identification information also facilitates in verifying if different flows are transmitted in accordance with appropriate rules. The generated data flows are transmitted with respective flow identification information in order to facilitate the verification process.

### CROSS-REFERENCE TO RELATED APPLICATIONS

This application claims the benefit of U.S. Provisional Patent Application Ser. No. 61/057,968 entitled “A METHOD AND APPARATUS FOR PCC ENHANCEMENT” which was filed Jun. 2, 2008. The entirety of the aforementioned application is herein incorporated by reference.

### BACKGROUND

I. Field

The following description relates generally to wireless communications, and more particularly to enhancing policy and charging control functions employed in a wireless communication system.

II. Background

Wireless communication systems are widely deployed to provide various types of communication, for instance, voice and/or data can be provided via such wireless communication systems. A typical wireless communication system, or network, can provide multiple users access to one or more shared resources (e.g., bandwidth, transmit power, . . . ). For instance, a system can use a variety of multiple access techniques such as Frequency Division Multiplexing (FDM), Time Division Multiplexing (TDM), Code Division Multiplexing (CDM), Orthogonal Frequency Division Multiplexing (OFDM), and others.

Generally, wireless multiple-access communication systems can simultaneously support communication for multiple access terminals. Each access terminal can communicate with one or more base stations via transmissions on forward and reverse links. The forward link (or downlink) refers to the communication link from base stations to access terminals, and the reverse link (or uplink) refers to the communication link from access terminals to base stations. This communication link can be established via a single-in-single-out, multiple-in-single-out or a multiple-in-multiple-out (MIMO) system.

MIMO systems commonly employ multiple (N_{T}) transmit antennas and multiple (N_{R}) receive antennas for data transmission. A MIMO channel formed by the N_{T} transmit and N_{R} receive antennas can be decomposed into N_{S} independent channels, which can be referred to as spatial channels, where N_{S}<{N_{T}, N_{R}}. Each of the N_{S} independent channels corresponds to a dimension. Moreover, MIMO systems can provide improved performance (e.g., increased spectral efficiency, higher throughput and/or greater reliability) if the additional dimensionalities created by the multiple transmit and receive antennas are utilized.

MIMO systems can support various duplexing techniques to divide forward and reverse link communications over a common physical medium. For instance, frequency division duplex (FDD) systems can utilize disparate frequency regions for forward and reverse link communications. Further, in time division duplex (TDD) systems, forward and reverse link communications can employ a common frequency region so that the reciprocity principle allows estimation of the forward link channel from reverse link channel.

Wireless communication systems generally employ one or more base stations that provide a coverage area to a plurality of UEs. A typical base station can transmit multiple data streams for broadcast, multicast and/or unicast services, wherein a data stream may be a stream of data that can be of independent interest to a UE. Likewise, a UE can transmit data to the base station or another UE. Various data streams relate to voice, video or other communication data generated by users or control data that determines the behavior of the UE and/or the network. Based on the type of data being transmitted and other considerations such as the type of service subscribed to by the user, different data streams can have different policy requirements associated therewith. Hence, accurate communication of these policies is required in order to receive or render the data correctly.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with facilitating ciphering in a wireless access communication system. Particularly, a method that facilitates tunneling in a wireless communication environment is disclosed in accordance with an aspect. The method comprises receiving one or more data flows or an indication that data flows might be received. The data flows are either generated by a UE or an access network in accordance with different aspects. Flow identification information is generated for each of the data flows. The flow identification information facilitates association of flow policies to the data flows. This is achieved by transmitting the generated flow identification information to a policy component which utilizes the information to identify the appropriate policies/rules to be implemented for each of the flows. The policies/rules can relate to charging aspects or QoS considerations. In a further aspect, a source address of a source from which the data flows originate or any tuple from IPv6 fields can also be transmitted in addition to the flow identification information, such that, for each of the data flows, a combination of source address and flow identification information acts as a unique identifier. The flow identification information generation can be a dynamic process based on a modality of access of the data flows. For example, if a UE in an initially trusted mode moves to an untrusted mode of access, the UE or the Home Agent may start encrypting the data flows. Under such circumstances, the flow identification information generation can be initiated in order to facilitate proper treatment of the encrypted data flow. Additionally, flow identification information of one or more other data flows can be received and compared with the identification information as determined by flow policies associated with the one or more other data flows to verify that the one or more other data flows were transmitted in accordance with appropriate policies.

Another aspect relates to a wireless communications apparatus, comprising a memory and a processor. The memory that retains instructions related to generating flow identification information for one or more data flows, and facilitating association of appropriate flow specific rules to the data flows by transmitting the generated flow identification information to a policy server. The processor coupled to the memory, is configured to execute the instructions retained in the memory. In a more detailed aspect, the encryption is activated upon detection of a change in access mechanism from a trusted access to an untrusted access. Additionally, a source address is used in addition to the flow identification information represented as flow labels to uniquely identify encrypted data flows.

A wireless communications apparatus that enables transmission of data flows in a wireless communication environment is disclosed in accordance with this aspect. The wireless communications apparatus comprises means for receiving, that receives one or more data flows or an indication that one or more data flows are to be received Means for generating flow identification information is employed for identifying each of the data flows. The apparatus also comprises a transmitting means for transmitting the generated flow identification information for association of the data flows with appropriate flow specific rules.

A computer program product, comprising a computer-readable medium with code for facilitating tunneling of data in a wireless communication system is disclosed in accordance with this aspect. The code facilitates receiving one or more data flows, generating flow identification information for each of the data flows and transmitting the generated flow identification information to a policy identifying component for association of appropriate flow specific rules to the data flows.

Another aspect relates to a wireless communications apparatus comprising a processor configured to facilitate communication of data flows. The processor is configured for receiving one of one or more data flows or an indication that one or more data flows are to be received and generating flow identification information for each of the data flows. It also facilitates association of appropriate flow policies to the data flows by transmitting the generated flow identification information to a policy determining function.

A method that facilitates tunneling in a wireless communication environment is disclosed in accordance with yet another aspect. This aspect relates to identifying one or more data flows wherein the data flows can be generated at a UE or can be received by a UE from another network. Appropriate policy rules to be implemented with the data flows are identified. The data flows are then transmitted in accordance with the policy rules to facilitate an access network to verify that the appropriate policy rules have been implemented for different data flows. In a further aspect, the QoS pipes for transmission of the data streams can be identified via the policy rules which can comprise one or more of charging rules or QoS rules. Additionally, the flow identification information can be transmitted in an outer header of the flows to facilitate the verification process.

A wireless communications apparatus comprising a memory and a processor is disclosed in accordance with another aspect. The memory that retains instructions related to retrieving flow identification information associated with data flows, identifying the policy rules to be implemented with the data flows and transmitting the data flows in accordance with the policy rules. The processor is coupled to the memory and is configured to execute the instructions retained in the memory.

A wireless communications apparatus that enables tunneling of data flows in a wireless communication environment is disclosed in accordance with this aspect. It comprises means for receiving flow ID information and means for matching flow ID information of a data packet to appropriate policy rules. Transmitting means, also comprised within the apparatus, facilitates transmitting the data packets in accordance with respective policy rules.

Another aspect relates to a computer program product, comprising a computer-readable medium. The medium comprises code for identifying one or more data flows, code for identifying one or more flow identification information associated with the data flows and code for identifying one or more policy rules to be implemented with the data flows. Code for transmitting the data flows in accordance with respective policy rules is also comprised within the medium.

A wireless communications apparatus, comprising a processor is disclosed in accordance with this aspect. The processor is configured to identifying one or more data flows, identifying flow identification information associated with the data flows such that the policy rules to be implemented with the data flows are also identified. Upon identification of the policy rules, the processor facilitates transmission of the data flows in accordance with respective policy rules.

A method that facilitates tunneling in a wireless communication environment is disclosed in accordance with yet another aspect. The method comprises receiving an indication associated with one or more data flows along with the flow identification information for each of the one or more data flows. Flow specific rules to be implemented for each of the data flows are determined. The flow identification information along with the flow specific rules are transmitted to facilitate communication of the one or more data flows in accordance with the determined rules. Different aspects relate to determining the rules based on existing rule sets comprising one or more of QoS rules or charging rules or dynamically determining the rules to be implemented for each of the data flows.

A wireless communications apparatus, comprising a memory and a processor is disclosed in accordance with yet another aspect. The memory retains instructions related to receiving flow identification information for one or more received data flows, and facilitating determination of appropriate flow specific rules for the data flows. A processor, coupled to the memory, is configured to execute the instructions retained in the memory.

A wireless communications apparatus that enables tunneling of data flows in a wireless communication environment is disclosed in accordance with this aspect. It comprises means for receiving an indication of one or more data flows and flow identification information for each of the one or more data flows. Means for determining, comprised within the apparatus, identifies flow specific rules to be implemented for each of the data flows. Means for transmitting the flow identification information facilitates transmission of the one or more data flows in accordance with the determined flow specific rules.

A computer program product, comprising a computer-readable medium is disclosed in this aspect. The computer-readable medium comprises code for receiving an indication associated with one or more data flows and flow identification information for each of the one or more data flows. Code for determining flow specific rules to be implemented for each of the data flows is also comprised within the medium. Code for transmitting the flow identification information facilitates transmission of the one or more data flows in accordance with the determined rules.

A wireless communications apparatus, comprising a processor is disclosed in accordance with this aspect. The processor is configured to receive an indication associated with one or more data flows and flow identification information for each of the data flows. It is further configured to determine flow specific rules to be implemented for each of the data flows and to facilitate transmission of the one or more data flows in accordance with the determined rules.

A method that facilitates tunneling in a wireless communication environment is disclosed in accordance with this aspect. The method comprises receiving an indication associated with one or more data flows transmitted in accordance with specific rules. Flow identification information for the received data flows is retrieved and communicated along with the data flows to facilitate verification that the data flows were transmitted in accordance with specific rules as determined by a policy component. In accordance with different aspects, the flow identification information comprises one or more of source addresses, DSCP or port numbers. Additionally, the specific rules can comprise one or more of charging rules of QoS rules.

A wireless communications apparatus, comprising a memory and a processor is disclosed in accordance with another aspect. The memory retains instructions related to receiving one or more data flows transmitted in accordance with specific rules, retrieving flow identification information associated with the specific rules and transmitting the flow identification information along with the data flows to facilitate verification of the specific rules. The processor, coupled to the memory, is configured to execute the instructions retained in the memory.

A wireless communications apparatus that enables tunneling of data flows in a wireless communication environment is disclosed in accordance with yet another aspect. It comprises means for receiving one or more data flows transmitted in accordance with specific rules, means for retrieving flow identification information associated with the specific rules and means for transmitting the flow identification information along with the data flows to facilitate verification of the specific rules.

A computer program product, comprising a computer-readable medium is disclosed in accordance with this aspect. The computer-readable medium comprises code for receiving one or more data flows transmitted in accordance with specific rules and code for retrieving flow identification information associated with the specific rules. It also comprises code for transmitting the flow identification information along with the data flows to facilitate verification of the specific rules.

A wireless communications apparatus, comprising a processor is disclosed in accordance with yet another aspect. The processor configured to receive one or more data flows transmitted in accordance with specific rules. It can further retrieve flow identification information associated with the specific rules and facilitate transmission of the flow identification information along with the data flows for verification of the specific rules.

Toward the accomplishment of the foregoing and related ends, the one or more embodiments comprise the features hereinafter fully described and particularly pointed out in the claims. The following description and the annexed drawings set forth herein detail certain illustrative aspects of the one or more embodiments. These aspects are indicative, however, of but a few of the various ways in which the principles of various embodiments can be employed and the described embodiments are intended to include all such aspects and their equivalents.

### BRIEF DESCRIPTION OF THE DRAWINGS

FIG. 1 is an illustration of a wireless communication system in accordance with various embodiments presented herein.

FIG. 2 is an illustration of a reference architecture of a 3GPP-LTE system in accordance with one aspect.

FIG. 3A is a schematic diagram of an access network element and a corresponding UE that can be used for facilitating tunneling support within communication systems.

FIG. 3B is a schematic diagram of an IP payload being transmitted in a communication tunnel with flow identification information.

FIG. 4 is an illustration of the signaling exchanged between various entities of a communication system that facilitates encryption of data.

FIG. 5 is an illustration of signaling exchanged between various entities of a communication system that facilitates encryption of data in accordance with a further aspect.

FIG. 6 is an illustration of is a methodology that facilitates generating flow labels for uniformly applying appropriate rules among the different network entities.

FIG. 7 is an illustration of a flow chart illustrating a methodology that facilitates tunneling in communication systems in accordance with another aspect.

FIG. 8 is a flow chart illustrating a methodology for facilitating enhancements to policy and charging control for tunneling of data.

FIG. 9A is a flow chart of a methodology that facilitates determining if various data flows are configured with the correct charging/QoS rules by a UE.

FIG. 9B is a flow chart of another methodology that facilitates determining if various data flows are configured with the correct charging/QoS rules by a UE.

FIG. 10 is an illustration of a flow chart detailing a methodology of dynamic Flow ID generation in accordance with an aspect.

FIG. 11 is an illustration of a wireless communication system in accordance with various embodiments presented herein.

FIG. 12 is an illustration of an example wireless network environment that can be employed in conjunction with the various systems and methods described herein.

FIG. 13 is an illustration of an example system that enables employing ciphering in a wireless communication environment.

FIG. 14 is another example system that enables implementation of proper policy rules for various packet flows within a communication system.

FIG. 15 is another example system that enables implementation of appropriate rules for various packet flows within a communication system.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

The techniques described herein can be used for various wireless communication systems such as code division multiple access (CDMA), time division multiple access (TDMA), frequency division multiple access (FDMA), orthogonal frequency division multiple access (OFDMA), single carrier-frequency division multiple access (SC-FDMA) and other systems. The terms “system” and “network” are often used interchangeably. A CDMA system can implement a radio technology such as Universal Terrestrial Radio Access (UTRA), CDMA2000, etc. UTRA includes Wideband-CDMA (W-CDMA) and other variants of CDMA. CDMA2000 covers IS-2000, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is an upcoming release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, CDMA2000 and UMB are described in documents from an organization named “3rd Generation Partnership Project 2” (3GPP2). Further, such wireless communication systems can additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Single carrier frequency division multiple access (SC-FDMA) utilizes single carrier modulation and frequency domain equalization. SC-FDMA has similar performance and essentially the same overall complexity as those of an OFDMA system. A SC-FDMA signal has lower peak-to-average power ratio (PAPR) because of its inherent single carrier structure. SC-FDMA can be used, for instance, in uplink communications where lower PAPR greatly benefits access terminals in terms of transmit power efficiency. Accordingly, SC-FDMA can be implemented as an uplink multiple access scheme in 3GPP Long Term Evolution (LTE) or Evolved UTRA.

Furthermore, various embodiments are described herein in connection with an access terminal. An access terminal can also be called a system, subscriber unit, subscriber station, mobile station, mobile, remote station, remote terminal, mobile device, user terminal, terminal, wireless communication device, user agent, user device, or user equipment (UE). An access terminal can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station can be utilized for communicating with access terminal(s) and can also be referred to as an access point, Node B, Evolved Node B (eNodeB, eNB) or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

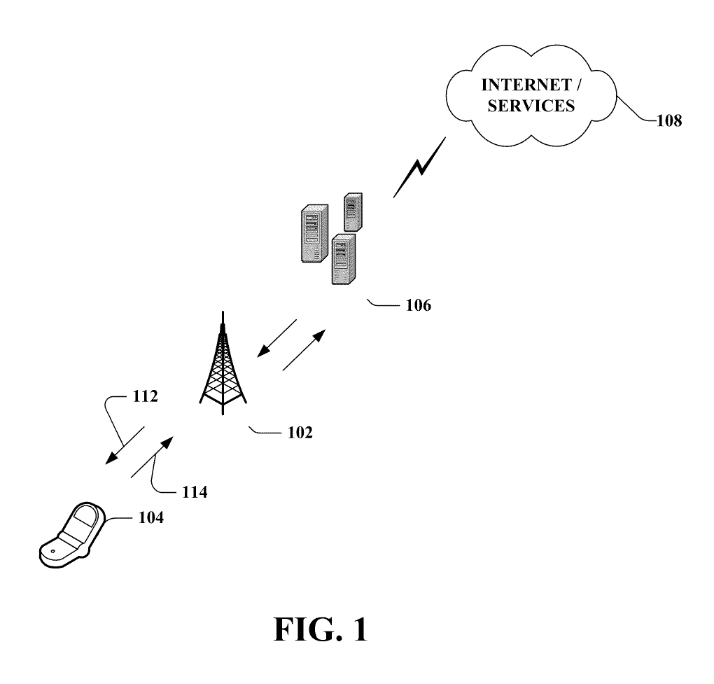

Referring now to FIG. 1, a wireless communication system 100 is illustrated in accordance with various embodiments presented herein. System 100 comprises a base station 102 that can include multiple antenna groups (not shown). Base station 102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art. Base station 102 can communicate with one or more access terminals such as access terminal 104; however, it is to be appreciated that base station 102 can communicate with substantially any number of access terminals similar to access terminal or UE (User Equipment) 104.

Examples of UE can be any one of cellular phones, smart phones, laptops, handheld communication devices, handheld computing/entertainment devices, satellite radios, global positioning systems, PDAs, and/or any other suitable device for communicating over wireless communication system 100. As depicted, UE 104 is in communication with the base station 102 which transmits information to the UE 104 over a forward link 112 and receives information from the UE 104 over a reverse link 114. The base station in turn can access various resources 106 to provide the UE 104 with the requested services 108. In accordance with different aspects, the resources can belong to a network in an area visited by the UE, namely, VPLMN (Visitor Public Land Mobile Network) or may be within the HPLMN (Home Public Land Mobile Network) of the UE 104. Based on the type of service request, appropriate resources for different user-user or user-network services are configured. For example, an FTP (File Transfer Protocol) server within the resources 106 can provide FTP service. Similarly, a HTTP (Hyper Text Transfer Protocol) server can provide Internet service or another operator can provide DNS service via another server. Additionally, the resources 106 facilitate implementation of charging rules and policies for different service data flows (SDF) arising from these service requests.

System 100 can also employ various coding/ciphering schemes for encrypting the data flow amongst the various network elements. Various nodes within the network are configured with different levels of access to the data. As a result, it can be problematic to implement the specific QoS rules for each of the different data flows at every step within the network. For example, while the UE 104, which is at one end of the encryption and the resources 106, which are at the other end of the encryption chain can view data packets within a communication tunnel. When encrypted, the packets may not be similarly transparent to the access functions associated with the base station 102 which facilitates transfer of the data packets there between. As a result, it can be difficult to implement the precise charging policies or quality considerations at such points. Additionally, it can enhance security of the system 100 if transit entities within a network can forward the payload without having to investigate the data packets within the communication tunnel. According to the various aspects described infra, the system 100 facilitates data access such that the flow specific rules such as charging rules or QoS rules for different data flows can be applied uniformly at various network nodes upon simple inspection of tunnel headers regardless of the transparency of the data packets within the various flows to the different network nodes.

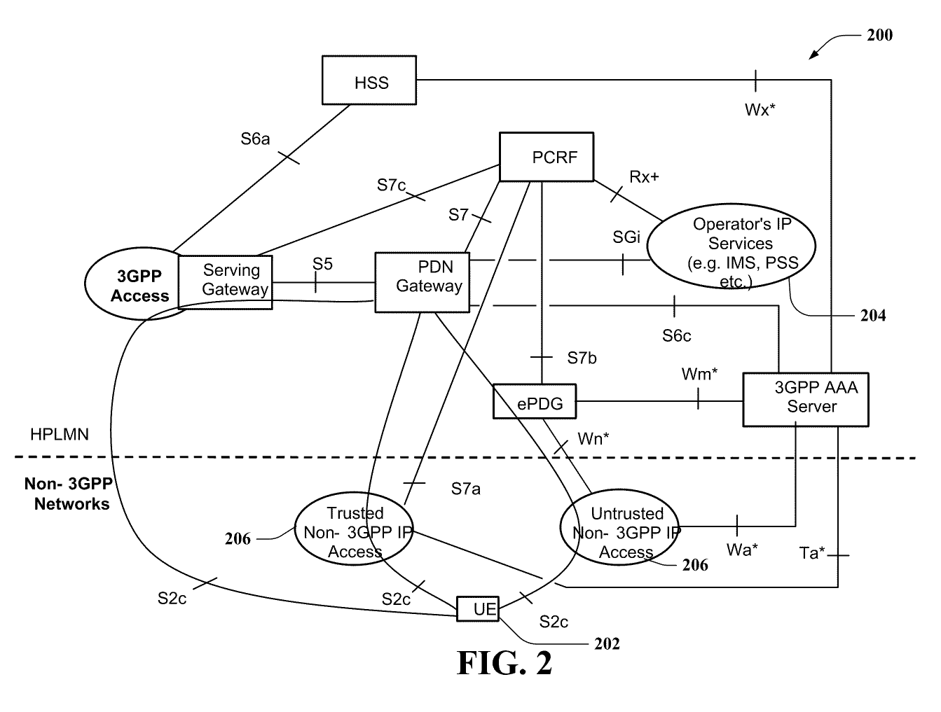

Now referring to FIG. 2, illustrated is reference architecture 200 of a 3GPP-LTE system in accordance with one aspect. Although for clarity various functional/logical nodes within the network are shown as separate entities, it can be appreciated that one physical network element can implement a plurality of these functional/logical nodes. The system 200 facilitates access to various services 204 by the UE 202 via different gateways. For example, the UE 202 can access the Internet or other operator IP services 204 via one of a trusted non-3GPP IP access such as Wi-Fi, WiMAX or an untrusted non-3GPP IP access commonly labeled in the figure as 206.

The UE 202 communicates with the access system via two types of IP-IP (Internet Protocol) Gateway logical functions for the user plane—the Serving Gateway and the Packet Data Network Gateway (PDN-GW) via the S2c interfaces. These network functions can be implemented in the same or disparate physical nodes such that Serving Gateways of a VPLMN serving the UE 202 can connect to PDN-GWs of other networks which direct the traffic from the UE 202 to various services 204. Additionally, the Serving GW communicates with the HSS (Home Subscriber Server) via the S6a interface while the HSS is in turn connected to a 3GPP AAA (Authentication Authorization and Accounting) server via a Wx* interface. The 3GPP AAA server also communicates with other network entities such as ePDG, non 3GPP access mechanisms 206 and PDN-GW via Wm*, Wa*, Ta* and S6c interfaces respectively. The PDN-GW communicates with a Serving-GW and IP Services via S5 and SGi interfaces respectively.

As discussed supra, the UE 202 can give rise to various data flows. Some flows can be user data generated at the UE 202 while other flows can relate to data received by the UE 202 that should be forwarded further to a network element. For example, one flow can facilitate browsing the Internet, while another flow can facilitate VoIP (Voice over Internet Protocol) services. By the way of illustration and not limitation, unidirectional flow of IP packets with the same source IP address and the same destination IP address and the same transport protocol can be referred to as an IP flow. The IP flows can be encapsulated and transported across various networks via communication channels that can be termed as IP tunnels. Additionally, each of these flows has specific rules to be implemented such as, QoS considerations or rules for charging a subscriber for services rendered associated therewith. In accordance with further aspects, these rules can be predetermined or they can be determined dynamically. For example, the QoS considerations can depend on the type of data being generated or type of service plan associated with the UE 202. These rules are determined by the PCRF (Policy and Charging Rules Function) and communicated to the various network elements via the different S7 network interfaces connecting the PCRF to the trusted/untrusted network access mechanisms, the PDN-GW and the Serving Gateway etc. as shown in the figure. In a further aspect, the PCRF communicates the rules to the BBERF (Bearer Binding and Event Reporting Function) present within each of these network elements associated with the S7 interfaces (not shown). The rules which can comprise description of an IP flow wherein the IP flow is identified by a filter, the source of the flow, for example, the IP address from which the flow originates, the destination of the flow, the protocol to be used with the flow, the description of the data within the flow and a methodology of treatment of the data etc. can all be determined at the PCRF associated with a HPLMN of the UE 202.

If Mobile IPv4 (MIP) or Dual Stack Mobile IPv6 (DSMIPv6) is used for the communication between the UE 202 and the PDN-GW as shown in the figure, a tunnel is established there between for communication of the data packets. This tunnel proceeds through the non-3GPP access mechanism as shown in the figure. In particular, depending on whether a trusted non-3GPP access mechanism or a untrusted non-3GPP access mechanism is used, one of the S7a interface or S7b interface through the Evolved Packet Data Gateway (ePDG) is used for communication of the data packets. Accordingly, the access mechanism detects the type of data packets within the tunnel, and confers with the PCRF to receive the appropriate treatment to be applied for the data packets. As mentioned supra, the system 200 can be enhanced if the access mechanism can identify the appropriate QoS treatment for the packets upon a simple inspection of the packet headers. Moreover, if the data flow within the tunnel is ciphered or encrypted, they would not be transparent to the BBERF within the access mechanism. Hence, the access mechanism cannot collaborate with the PCRF to give implement flow specific rules, for example, a correct QoS treatment to the data packets within the tunnel.

In a further aspect, whenever payload is tunneled from the UE 202 to a Home Agent (not shown), an identifier is allocated to the IP flow by the PDN-GW. This is communicated within a header associated with the data packets to at least a subset of the network elements. This facilitates, for example, the PCRF to determine the appropriate flow specific rules to be employed for the encrypted packets and communicate such rules to the non-3GPP access mechanism. The access mechanism can match the rules to the specific IP flows via the flow identifiers thereby facilitating in smooth operation of the communication system 200. Upon termination of an encrypted session, the system 200 can return to communication of the policy rules via the S7 interfaces wherein the access mechanism confers with the PCRF based on a sampling of the data packets within the flows. Thus, instead of implementing a methodology that requires an access mechanism to have knowledge of the nature of data packets within the IP flows, various aspects relate to providing identification information in the form of a label, a pointer or an identifier for the IP flows including a tuple of IPv6 fields with source address and DSCP (Differentiated Services Code Point), as well as transport layer port numbers (when UDP tunneling is used) within the payload header. This facilitates implementation of the correct flow specific rules even while the nature of the data packets within the flows remains unknown.

In a further aspect, a source address can be used in addition to the flow ID to identify specific data flows. Thus, for a given source, the combination of flow ID and source address is unique. This facilitates the UE 202 to receive flows with the same flow ID from different sources or disparate PDN-GWs. For example, the UE 202 can receive flows with the same flow IDs originating from its Internet service access or access to VoIP service since the combination of source address and flow ID would be unique.

In another aspect, the flow identification information can be utilized to verify if the UE 202 has used the correct policies/rules for the appropriate data packets on uplink communications. As discussed supra, the data packets within a flow may not be transparent to the access mechanisms 206. Hence, while the PDN-GW can identify if the correct treatment has been applied to the flows it received from the appropriate access mechanism 206, it cannot determine if the same is true for flows between the UE 202 and the access mechanism 206. For example, it may be possible that the UE has applied the wrong QoS categories to the data packets while communicating with the access mechanism 206. However, this can be mitigated by the use of the flow identification as detailed herein. The UE 202 can receive flow identification information from the PDN-GW or alternatively, the UE 202 can generate flow IDs for specific mobile originated data flows. The flow ID can be used for placing the data packets in the appropriate QoS pipes by the UE 202. When the PDN-GW receives the labeled flows from the UE 202 via the access mechanism 206, it can employ the flow IDs to verify that the UE 202 has applied the correct QoS rules for the data flows. In a further aspect, the flow ID can be a 8-bit or 16-bit value within outer IP-header for labeling specific data flows.

Another aspect relates to including the flow identification information to uplink data packets by the access mechanism 206 or the Serving Gateway. In this aspect, the UE 202 transmits the data flows to the access mechanism 206/Serving Gateway through one or more QoS pipes in accordance with particular rules. The access mechanism 206/Serving GW has information regarding particular Flow identification information associated with respective QoS pipes utilized by the UE 202 for the data flow (based on the policy it has received from policy server). The access mechanism 206 can then append flow identification information such as flow labels etc. to an outer header of the data packet and transmit the packets to the PDN-GW or a Home Agent. The PDN-GW upon receiving the data flows along with the flow identification information can compare the flow identification information received from the access mechanism 206/Serving Gateway to the flow identification information associated with policies of the data flows as determined and communicated to it by the PCRF. Thus, the PDN-GW can verify that the data flows were transmitted by the UE 202 to the access mechanism 206/Serving GW in accordance with flow specific policies as determined by the PCRF. Thus, labeling or identifying data flows not only facilitates various network elements to uniformly apply charging/QoS rules, it also provides a verification mechanism for determining that a UE has treated each data flow with the correct rules.

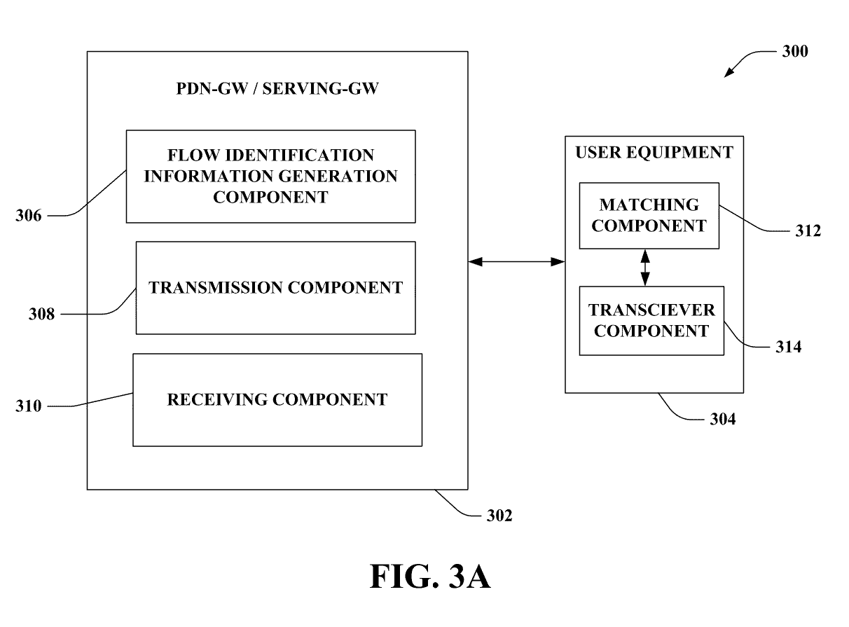

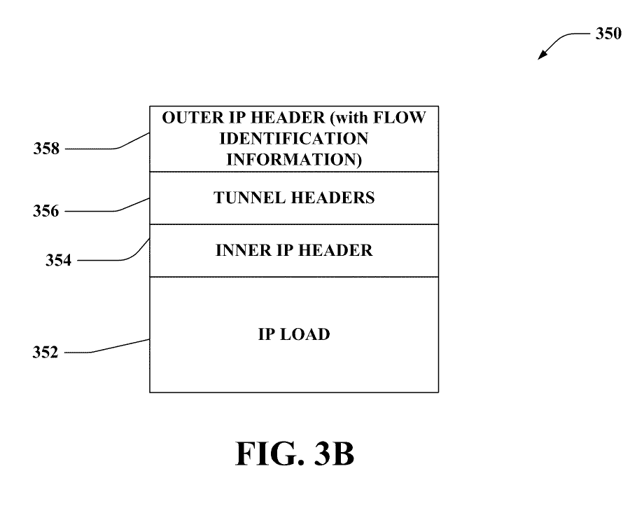

FIG. 3a is a schematic diagram 300 of an access network element and a corresponding UE that can be used for facilitating tunneling support within communication systems. As discussed supra, the various functional/logical entities that facilitate ciphering support within a network such as the PCRF, PDN-GW, Serving GW (Serving Gateway), or the BBERF can be implemented by the same or disparate physical elements of the network. Accordingly, the physical element 302 within the network that implements the PDN-GW and/or the Serving GW can comprise a flow identification information generation component 306 in addition to a transmission component 308 and a receiving component 310. The receiving component 310 can receive one or more data flows, or, in another aspect, the receiving component 310 can receive an indication from another network element, such as a policy server, that one or more data flows are to be received. Upon receiving such communication, the flow ID generation component 306 associated with the PDN-GW 302 can be employed to generate a label/pointer/flow ID for each of the IP flows. In accordance with a specific aspect, the flow identification information generation component 306 can start labeling data flows when the UE 304 and the PDN-GW 302 decide to turn on encryption/ciphering for particular flows. Although for simplicity, the UE 304 is shown to be communicating with a single PDN-GW 302, it is possible for the UE 304 to communicate with a plurality of PDN-GWs for access to different types of services as detailed herein. In this case, a combination of HA (Home Agent) address assigning the flow identification information can be used along with the flow identification information to uniquely identify each of the plurality of flows associating the UE 304 with the plurality of PDN-GWs. A transmission component 308 is employed to communicate the generated flow identification information to a policy server (not shown) executing the PCRF that determines the QoS rules to be implemented for the flow associated with the generated flow identification information. The policy server can then communicate the flow identification information along with the QoS rules to an access mechanism such as a trusted/non-trusted 3GPP mechanism as detailed supra for implementation.

The UE 304 can receive data flow along with the associated flow identification information from the network on the downlink while transmitting data to a network on the uplink via the transceiver component 314. The UE 304 can employ one of a trusted or untrusted non-3GPP access mechanism for receiving or sending data to the network. As detailed herein, the access mechanism communicates data from the UE 304 to an appropriate PDN-GW on the uplink. The PDN-GW can receive a flow along with the flow identification information from the UE 304 wherein the flow identification information is employed to verify that the UE 304 has implemented correct policies for uplink transmissions. For example, the flow identification information can be used to verify QoS rules for particular flows wherein it is verified the data packets on the uplink were assigned to the correct QoS pipes. This matching between the flow ID and the appropriate flow policies, such as QoS category, is facilitated at the UE 304 via the matching component 312 which includes the flow identification information with the data flow. Thus, the flow identification information mechanism can be employed on the uplink to establish a charging/QoS check on the UE 304.

FIG. 3b is a schematic diagram of an IP payload being transmitted in a communication tunnel with flow identification information. When a payload is transmitted from a UE to a Home Agent or vice versa, a native routing path via an IP tunnel is established across the intermediate network. IP tunnels are often used in to connect, for example, Ipv6 implementations with Ipv4 implementations. In IP tunneling, each IP payload 352 is configured with information regarding original source and recipient in the inner IP header 354 while the outer IP header 358 comprises source and destination information identifying the “endpoints” of the tunnel. Other intermediate tunnel headers 356 for forwarding the payload may optionally be included based on, for example, the communication protocols being used etc. At the tunnel end points, packets traversing the end-points from the transit network are stripped from their transit headers and trailers used in the tunneling protocol and thus converted into native protocol format and injected into the stack. In a more detailed aspect, the flow identification information in the form of flow labels, pointers or flow IDs can be included in the outer IP header 358 as shown. This can allow the PCRF and eventually the BBERF to identify a tunnel flow by inspecting the outer header 358.

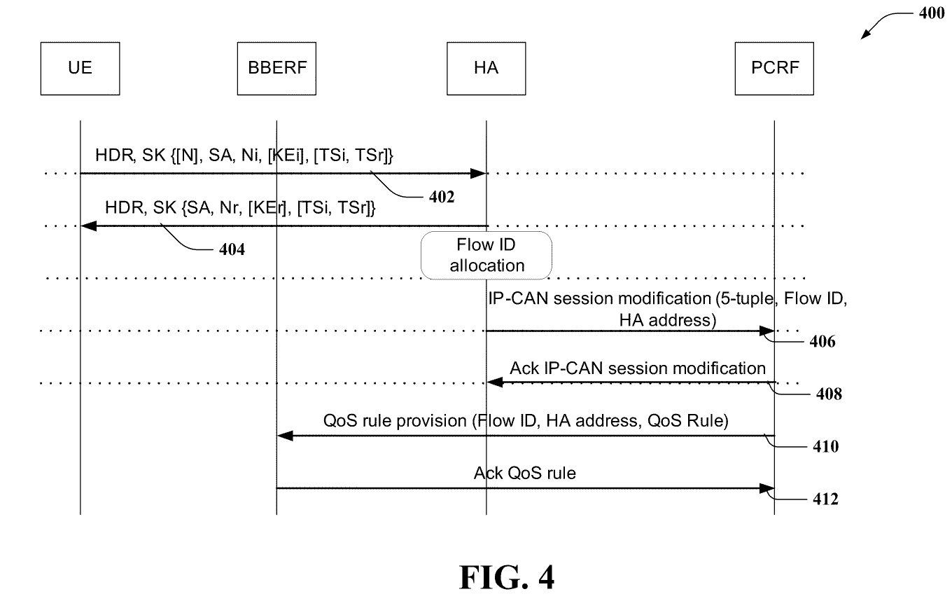

FIG. 4 illustrates signaling exchanged between various entities of a communication system that facilitates encryption of data. As seen from the figure, the UE and a corresponding Home Agent (for example, an IP termination point within a PDN-GW) initially set up encryption of data flow exchanged there between via the messages 402 and 404, wherein TSi and TSr selectors refer to the 5-tuple (including ranges and wildcard) which need to be ciphered. The Home Agent function allocates a flow ID that relates to the flow upon turning on the data encryption. When the HA turns on encryption for a flow, it generates a Flow ID and sends the flow description, the HA address and the Flow ID to the PCRF. This is communicated by the HA to the PCRF via the IP-CAN (IP Connectivity Access Network) session modification conveyed on 406. In particular, the IP-CAN session modification message can comprise the IP 5-tuple, a flow ID assigned by the HA and a HA address. Generally, the IP 5-tuple comprises source IP address, destination IP address, source port number(s), destination port number(s) and a protocol ID. In response, the HA receives an ACK (Acknowledgement) of the IP-CAN session modification from the PCRF on 408. The PCRF provides the BBERF with the QoS rules associated with the flow together with the Flow ID and the HA Address (as the Flow ID is unique per source address) as a combination of Flow ID and source address (HA address) is used to perform the SDF (Synchronous Data Flow) identification for downlink packets. Accordingly, the PCRF transmits message 410 comprising the Flow ID, HA Address, and associated QoS rules to the BBERF associated with the UE. In accordance with various aspects, the BBERF can be implemented at a location wherein a S7 interface terminates. For example, based on a UE access, the BBERF can be implemented at ePDG or a trusted non 3GPP access network in accordance with different aspects. In response the PCRF receives an ACK message 412 for the QoS rule.

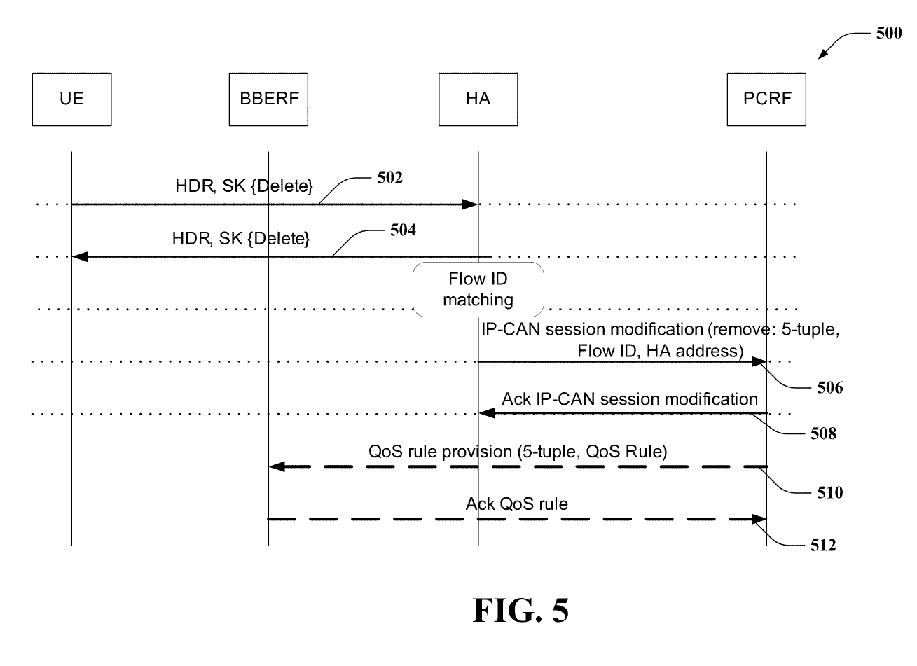

FIG. 5 illustrates signaling 500 exchanged between various entities of a communication system that facilitates encryption of data in accordance with a further aspect. Due to various reasons, for example, a UE moving from an untrusted to a trusted access, the UE or the HA can deactivate the encryption of a flow previously protected. This can be achieved via an informational exchange with DELETE payload. Accordingly, signals 502 and 504 are exchanged between a UE and a HA with delete payload. This results in a IP-CAN session modification removing the Flow ID and additionally, the HA address that may have been communicated along with the Flow ID via 506. Message 508 signals an ACK of the IP-CAN session modification by the PCRF. Accordingly, PCRF provides the BBERF with QoS rule provision using the 5-tuple alone instead of a Flow ID within 510. An acknowledgement (ACK) of the QoS rule 512 is transmitted by the BBERF in response to 510. Therefore, this aspect relates to switching off the Flow ID mechanism to facilitate QoS rule communication via employing the 5-tuple. This mitigates redundant signaling of the Flow ID within the network. Thus, based on necessity, the Flow ID can be dynamically employed to identify data packets to various network entities.

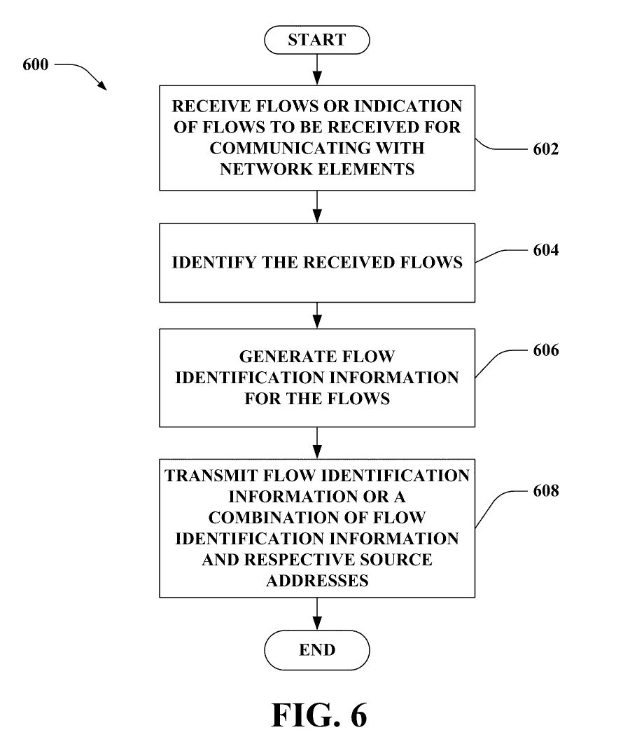

Referring to FIGS. 6-10, methodologies relating to PCC enhancement via employment of flow label in a wireless communication environment are illustrated. While, for purposes of simplicity of explanation, the methodologies are shown and described as a series of acts, it is to be understood and appreciated that the methodologies are not limited by the order of acts, as some acts can, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts can be required to implement a methodology in accordance with one or more embodiments.

With reference to FIG. 6, illustrated is a methodology 600 that facilitates generating flow information for uniformly applying QoS rules among the different network entities. The method commences at 602 wherein one or more flows are received for communicating to other network elements or an indication is received from another network element that one or more flows are to be received. For example, the received flows can be associated can be a response comprising control information or data from the server to a UE for a service request etc. At 604 each of the received data flows are identified such that for each of the identified data flow, identification information in the form of a Flow ID, a Flow label or a pointer is generated as shown at 606. In an aspect, the Flow Id can be a 8 bit or a 16 bit value communicated in the outer IP header of the data flow. A further aspect relates to generating the flow identification information represented as a Flow ID for each data flow such that a combination of source address and the Flow ID is unique for each flow associated with a specific source. The generated flow identification information is transmitted to the PCRF for association with appropriate policies as shown at 608 and the method subsequently terminates on the end block.

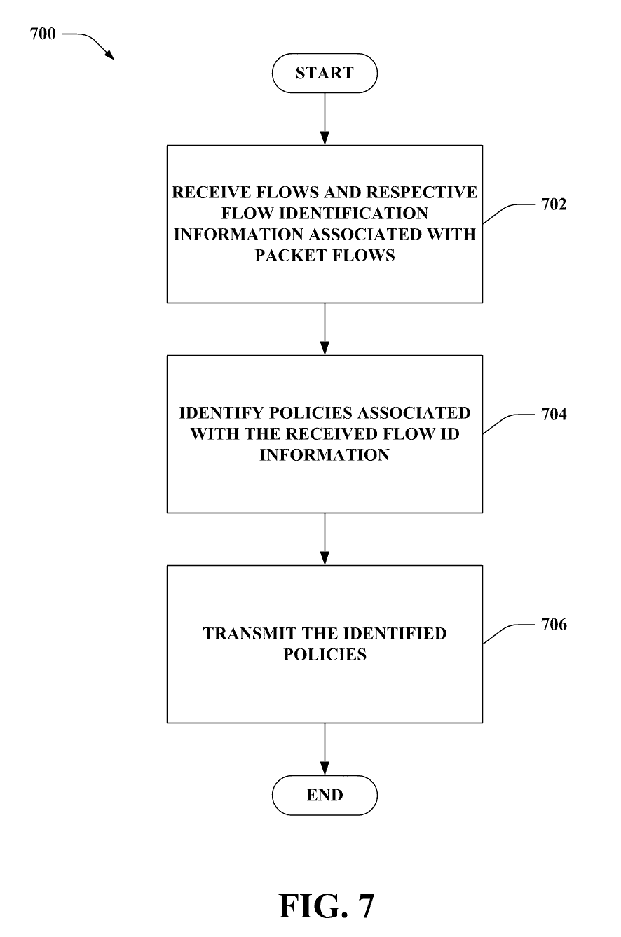

FIG. 7 is a flow chart illustrating a methodology 700 that facilitates tunneling in communication systems in accordance with another aspect. The method commences at 702 wherein one or more packet flows and related flow identification information such as Flow ID, a Flow label or a pointer associated with the one or more packet flows are received. Additionally, the HA address for the Flow IDs can be received such that a combination of HA address and the Flow ID is unique for each flow. At 704, the Flow identification information can be used to identify the policies such as charging rules and/or QoS rules for the related data flows. A PCC rule may be predefined or dynamically provisioned at establishment and during the lifetime of an IP-CAN session. The identified policies are transmitted to an access mechanism for application with the data flow associated with the received flow identification information as shown at 706. The procedure eventually terminates on the end block.

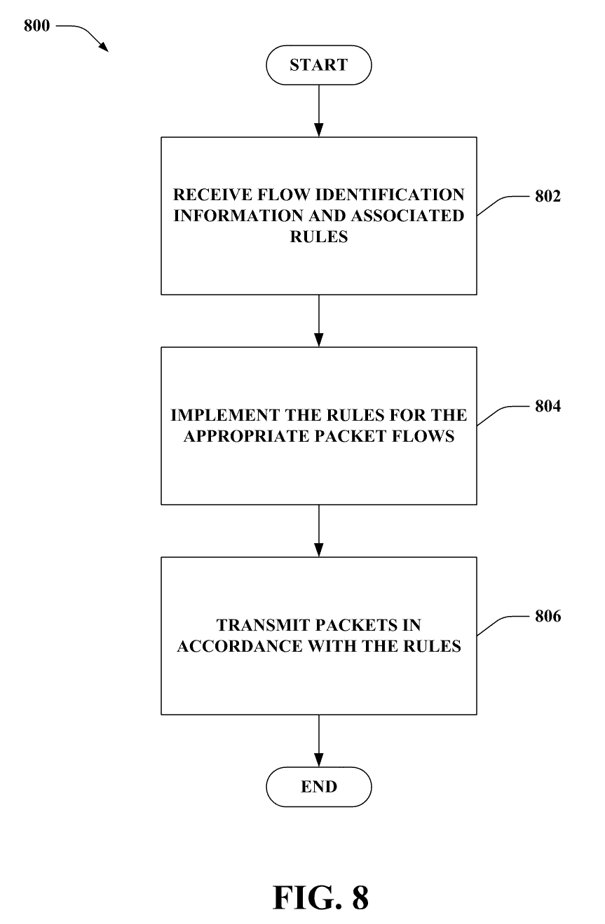

FIG. 8 is a flow chart illustrating a methodology 800 for facilitating enhancements to policy and charging control (PCC) in order to facilitate tunneling of data. The method begins at 802 wherein flow identification information and associated PCC rules are received for implementing with a data flow. At 804, the received rules are implemented for the data flow and the data packets are transmitted in accordance with the rules, for example, the rules can be QoS rules that facilitate transmission of the data packets in the appropriate QoS pipes as shown at 806. The method eventually terminates at the end block.

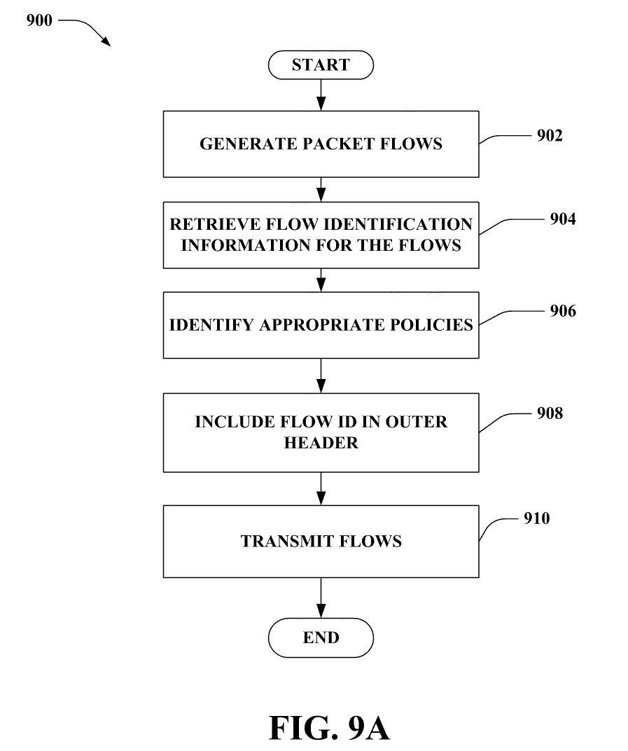

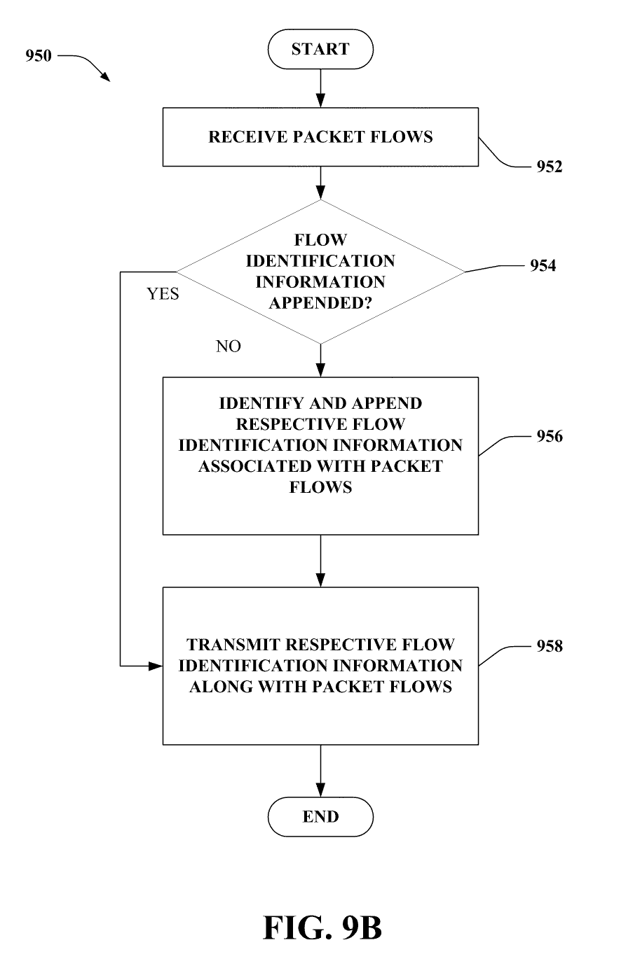

Turning to FIG. 9a, illustrated is a methodology 900 that facilitates determining if various data flows are configured with the correct policies. As discussed supra, when the traffic is encrypted within the DSMIPv6 tunnel the BBERF has no visibility of the inner header. The BBERF cannot detect the SDF and hence cannot apply the respective policies such as, QoS rules. A mechanism to identify ciphered flows and to provide the BBERF with the correct rules for those flows described herein can also be employed for verifying if a UE has implemented the appropriate policies, for example, employing the correct QoS pipes for transmitting the data packets. Accordingly, at 902, one or more packet flows are identified and the appropriate flow identification information for the generated packets is retrieved at 904. Appropriate policies, such as the QoS pipes to be employed for these flows can be identified as shown at 906. The identification information for each packet, such as the Flow ID for the packet flow is included in the outer head as shown 908. The packets are eventually transmitted as shown at 910. Inclusion of Flow ID in the outer header facilitates identification of appropriate charging/QoS rules by all the network elements. This facilitates verification that the UE has employed the rules appropriately for different packet flows.

With reference to FIG. 9b, illustrated is a methodology 950 that facilitates determining if various data flows are configured with the correct policies in accordance with another aspect. For example, if data flows are received at an access mechanism such as a Serving GW via specific QoS pipes from a UE with out the flow identification information, and forwarded to a Home Agent, the Home Agent may not be able to determine if the communication between the UE and the access mechanism was conducted in accordance with the rules determined by a policy component such as the PCRF. Thus, it can enhance security of a system if the access mechanism in conjunction with the HA can facilitate verification of the rules in accordance with which the flows were transmitted as detailed herein. The methodology begins at 952, wherein one or more flows transmitted in accordance with particular rules are received at the access mechanism. In accordance with a further aspect, the flows can be encrypted. At 954, it is determined if the flows are appended with respective flow identification information. If yes, the process branches out to 958 wherein the flows along with the flow identification information are forwarded to the HA to facilitate the verification that the particular rules were rules for the packet flows as determined by the policy component. If it is determined at 954, that the flow identification information was not appended to the flows, the flow identification information associated with the particular rules as known at the access mechanism is appended to the flows at 956 and subsequently the flows are transmitted as shown at 958. The procedure eventually terminates at the end block.

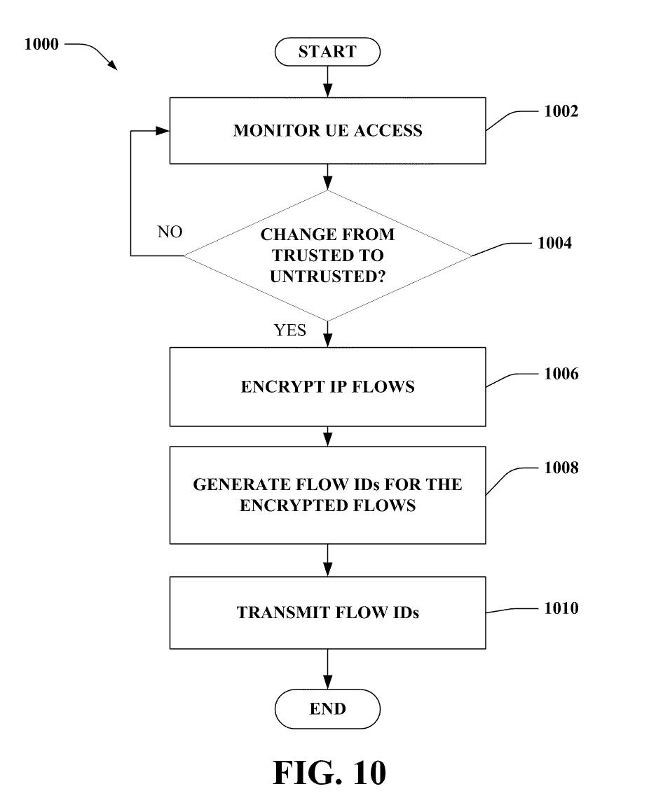

FIG. 10 is a flow chart detailing a methodology of dynamic Flow ID generation in accordance with an aspect. The method begins at 1002 wherein the access modalities of a UE are monitored. As discussed supra, the UE can access desired services via various modalities such as a trusted non-3GPP access or an untrusted non-3GPP access. Additionally, the access means of a UE can also change dynamically. Such dynamic changes in UE access of services can be detected. For example, if the UE moves to an untrusted access modality from a trusted network as shown at 1004, the data packets are ciphered. Either the PDNGW or the UE can cipher the packets as shown at 1006. As a result, some network elements may not be able to perceive the packets in the flow to apply the appropriate policies. Therefore, the flow identification information, such as pointers or Flow IDs are generated for labeling the flows as shown at 1008. At 1010, the flow identification information can be transmitted to the elements within the network that need to implement appropriate QoS treatments to the packets. Thus, flow identification information can be dynamically generated upon change of access modalities to implement correct policies for the packet flows.

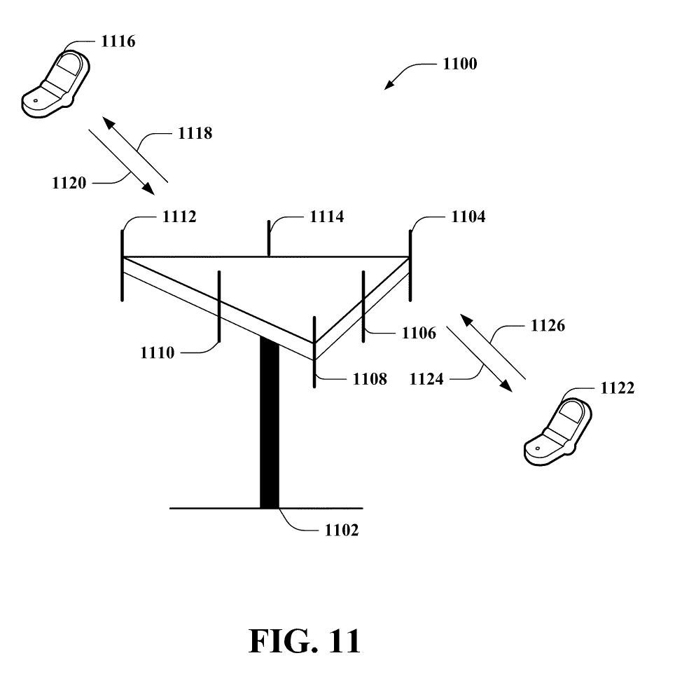

Referring now to FIG. 11, a wireless communication system 1100 is illustrated in accordance with various embodiments presented herein. System 1100 comprises a base station 1102 that can include multiple antenna groups. For example, one antenna group can include antennas 1104 and 1106, another group can comprise antennas 1108 and 1110, and an additional group can include antennas 1112 and 1114. Two antennas are illustrated for each antenna group; however, more or fewer antennas can be utilized for each group. Base station 1102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 1102 can communicate with one or more access terminals such as access terminal 1116 and access terminal 1122; however, it is to be appreciated that base station 1102 can communicate with substantially any number of access terminals similar to access terminals 1116 and 1122. Access terminals 1116 and 1122 can be, for example, cellular phones, smart phones, laptops, handheld communication devices, handheld computing devices, satellite radios, global positioning systems, PDAs, and/or any other suitable device for communicating over wireless communication system 1100. As depicted, access terminal 1116 is in communication with antennas 1112 and 1114, where antennas 1112 and 1114 transmit information to access terminal 1116 over a forward link 1118 and receive information from access terminal 1116 over a reverse link 1120. Moreover, access terminal 1122 is in communication with antennas 1104 and 1106, where antennas 1104 and 1106 transmit information to access terminal 1122 over a forward link 1124 and receive information from access terminal 1122 over a reverse link 1126. In a frequency division duplex (FDD) system, forward link 1118 can utilize a different frequency band than that used by reverse link 1120, and forward link 1124 can employ a different frequency band than that employed by reverse link 1126, for example. Further, in a time division duplex (TDD) system, forward link 1118 and reverse link 1120 can utilize a common frequency band and forward link 1124 and reverse link 1126 can utilize a common frequency band.

Each group of antennas and/or the area in which they are designated to communicate can be referred to as a sector of base station 1102. For example, antenna groups can be designed to communicate to access terminals in a sector of the areas covered by base station 1102. In communication over forward links 1118 and 1124, the transmitting antennas of base station 1102 can utilize beamforming to improve signal-to-noise ratio of forward links 1118 and 1124 for access terminals 1116 and 1122. Also, while base station 1102 utilizes beamforming to transmit to access terminals 1116 and 1122 scattered randomly through an associated coverage, access terminals in neighboring cells can be subject to less interference as compared to a base station transmitting through a single antenna to all its access terminals.

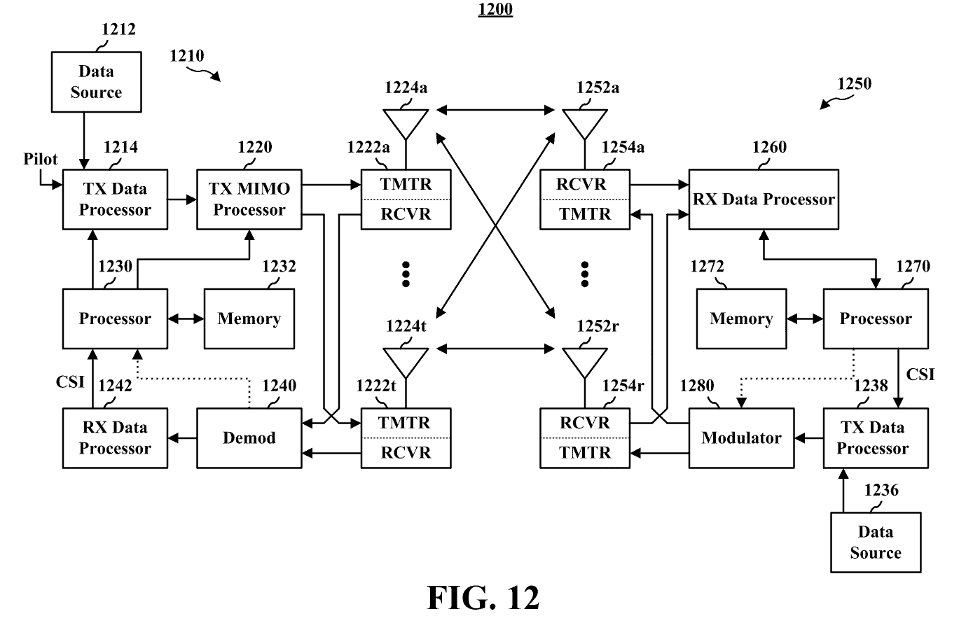

FIG. 12 shows another example of a wireless communication system 1200. The wireless communication system 1200 depicts one base station 1210 and one access terminal 1250 for sake of brevity. However, it is to be appreciated that system 1200 can include more than one base station and/or more than one access terminal, wherein additional base stations and/or access terminals can be substantially similar or different from example base station 1210 and access terminal 1250 described below. In addition, it is to be appreciated that base station 1210 and/or access terminal 1250 can employ the systems (FIGS. 1-3, and 13) and/or methods (FIGS. 6-10) described herein to facilitate wireless communication there between.

At base station 1210, traffic data for a number of data streams is provided from a data source 1212 to a transmit (TX) data processor 1214. According to an example, each data stream can be transmitted over a respective antenna. TX data processor 1214 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at access terminal 1250 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1230.

The modulation symbols for the data streams can be provided to a TX MIMO processor 1220, which can further process the modulation symbols (e.g., for OFDM). TX MIMO processor 1220 then provides N_{T} modulation symbol streams to N_{T} transmitters (TMTR) 1222a through 1222t. In various embodiments, TX MIMO processor 1220 applies beamforming weights to the symbols of the data streams and to the antenna from which the symbol is being transmitted.

Each transmitter 1222 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 1222a through 1222t are transmitted from N_{T} antennas 1224a through 1224t, respectively.

At access terminal 1250, the transmitted modulated signals are received by N_{R} antennas 1252a through 1252r and the received signal from each antenna 1252 is provided to a respective receiver (RCVR) 1254a through 1254r. Each receiver 1254 conditions (e.g., filters, amplifies, and downconverts) a respective signal, digitizes the conditioned signal to provide samples, and further processes the samples to provide a corresponding “received” symbol stream.

An RX data processor 1260 can receive and process the N_{R} received symbol streams from N_{R} receivers 1254 based on a particular receiver processing technique to provide N_{T} “detected” symbol streams. RX data processor 1260 can demodulate, deinterleave, and decode each detected symbol stream to recover the traffic data for the data stream. The processing by RX data processor 1260 is complementary to that performed by TX MIMO processor 1220 and TX data processor 1214 at base station 1210.

A processor 1270 can periodically determine which available technology to utilize as discussed above. Further, processor 1270 can formulate a reverse link message comprising a matrix index portion and a rank value portion.

The reverse link message can comprise various types of information regarding the communication link and/or the received data stream. The reverse link message can be processed by a TX data processor 1238, which also receives traffic data for a number of data streams from a data source 1236, modulated by a modulator 1280, conditioned by transmitters 1254a through 1254r, and transmitted back to base station 1210.

At base station 1210, the modulated signals from access terminal 1250 are received by antennas 1224, conditioned by receivers 1222, demodulated by a demodulator 1240, and processed by a RX data processor 1242 to extract the reverse link message transmitted by access terminal 1250. Further, processor 1230 can process the extracted message to determine which precoding matrix to use for determining the beamforming weights.

Processors 1230 and 1270 can direct (e.g., control, coordinate, manage, etc.) operation at base station 1210 and access terminal 1250, respectively. Respective processors 1230 and 1270 can be associated with memory 1232 and 1272 that store program codes and data. Processors 1230 and 1270 can also perform computations to derive frequency and impulse response estimates for the uplink and downlink, respectively.

In an aspect, logical channels are classified into Control Channels and Traffic Channels. Logical Control Channels can include a Broadcast Control Channel (BCCH), which is a DL channel for broadcasting system control information. Further, Logical Control Channels can include a Paging Control Channel (PCCH), which is a DL channel that transfers paging information. Moreover, the Logical Control Channels can comprise a Multicast Control Channel (MCCH), which is a Point-to-multipoint DL channel used for transmitting Multimedia Broadcast and Multicast Service (MBMS) scheduling and control information for one or several MTCHs. Generally, after establishing a Radio Resource Control (RRC) connection, this channel is only used by UEs that receive MBMS (e.g., old MCCH+MSCH). Additionally, the Logical Control Channels can include a Dedicated Control Channel (DCCH), which is a Point-to-point bi-directional channel that transmits dedicated control information and can be used by UEs having a RRC connection. In an aspect, the Logical Traffic Channels can comprise a Dedicated Traffic Channel (DTCH), which is a Point-to-point bi-directional channel dedicated to one UE for the transfer of user information. Also, the Logical Traffic Channels can include a Multicast Traffic Channel (MTCH) for Point-to-multipoint DL channel for transmitting traffic data.

In an aspect, Transport Channels are classified into DL and UL. DL Transport Channels comprise a Broadcast Channel (BCH), a Downlink Shared Data Channel (DL-SDCH) and a Paging Channel (PCH). The PCH can support UE power saving (e.g., Discontinuous Reception (DRX) cycle can be indicated by the network to the UE, . . . ) by being broadcasted over an entire cell and being mapped to Physical layer (PHY) resources that can be used for other control/traffic channels. The UL Transport Channels can comprise a Random Access Channel (RACH), a Request Channel (REQCH), a Uplink Shared Data Channel (UL-SDCH) and a plurality of PHY channels.

The PHY channels can include a set of DL channels and UL channels. For example, the DL PHY channels can include: Common Pilot Channel (CPICH); Synchronization Channel (SCH); Common Control Channel (CCCH); Shared DL Control Channel (SDCCH); Multicast Control Channel (MCCH); Shared UL Assignment Channel (SUACH); Acknowledgement Channel (ACKCH); DL Physical Shared Data Channel (DL-PSDCH); UL Power Control Channel (UPCCH); Paging Indicator Channel (PICH); and/or Load Indicator Channel (LICH). By way of further illustration, the UL PHY Channels can include: Physical Random Access Channel (PRACH); Channel Quality Indicator Channel (CQICH); Acknowledgement Channel (ACKCH); Antenna Subset Indicator Channel (ASICH); Shared Request Channel (SREQCH); UL Physical Shared Data Channel (UL-PSDCH); and/or Broadband Pilot Channel (BPICH).

It is to be understood that the embodiments described herein can be implemented in hardware, software, firmware, middleware, microcode, or any combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

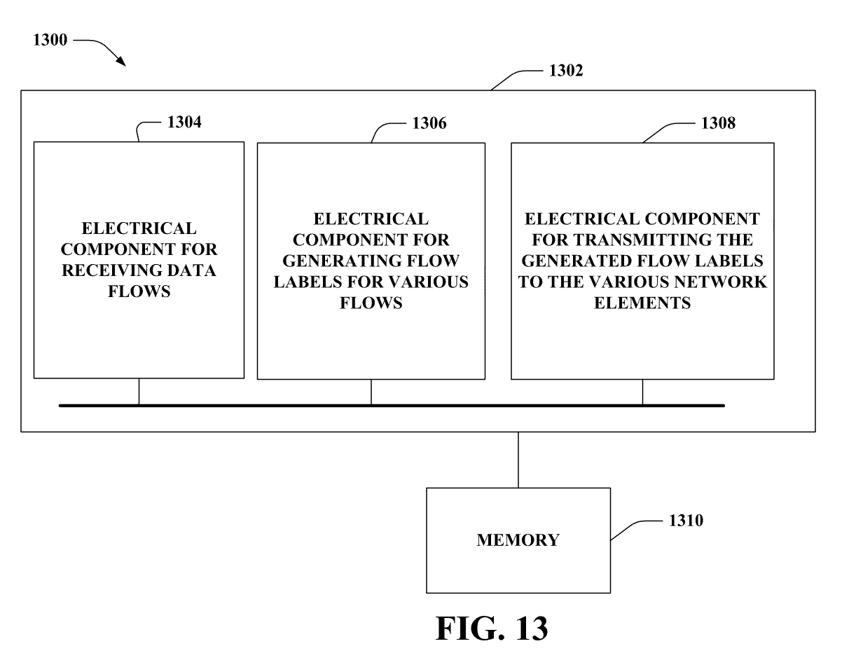

With reference to FIG. 13, illustrated is a system 1300 that enables employing ciphering in a wireless communication environment. For example, system 1300 can reside within a network element. It is to be appreciated that system 1300 is represented as including functional blocks, which can be functional blocks that represent functions implemented by a processor, software, or combination thereof (e.g., firmware). System 1300 includes a logical grouping 1302 of electrical components that can act in conjunction. For instance, logical grouping 1302 can include an electrical component for receiving one or more data flows 1304. In accordance with different aspects, these data flows could have originated on the access network in response to a service request or as part of a paging signal etc. Further, logical grouping 1302 can include an electrical component for generating flow identification information such as Flow IDs or Flow labels for different flows 1306 and an electrical component for transmitting the flow identification information 1308. Additionally, system 1300 can include a memory 1310 that retains instructions for executing functions associated with electrical components 1304, 1306 and 1308. While shown as being external to memory 1310, it is to be understood that one or more of electrical components 1304, 1306 or 1308 can exist within memory 1310.

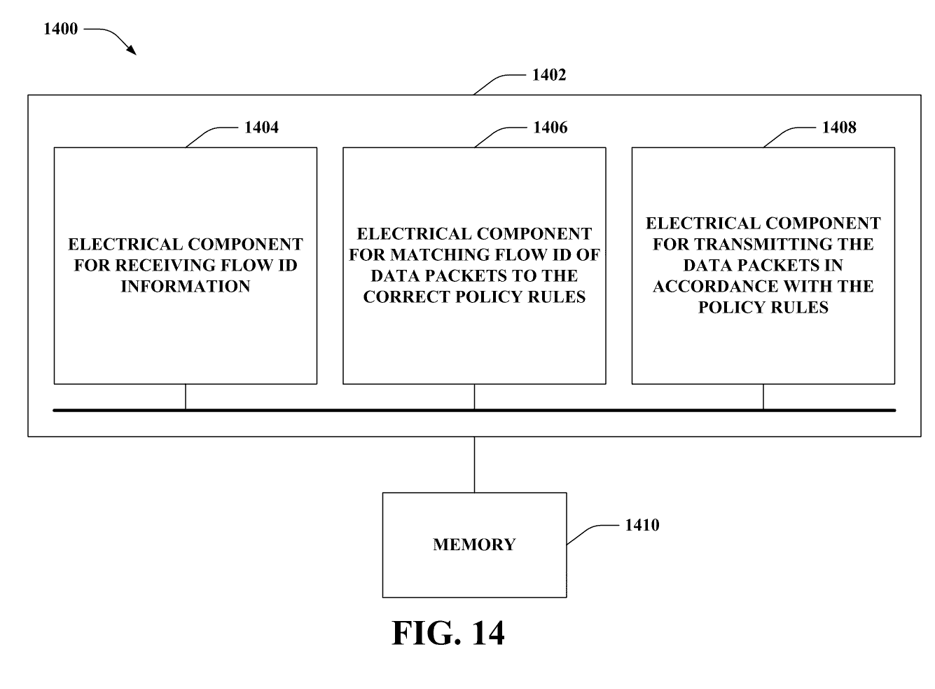

FIG. 14 is another example system 1400 that enables implementation of proper rules for various packet flows within a communication system. For example, system 1400 can reside within a UE. It is to be appreciated that system 1400 is represented as including functional blocks, which can be functional blocks that represent functions implemented by a processor, software, or combination thereof (e.g., firmware). System 1400 includes a logical grouping 1402 of electrical components that can act in conjunction. For example, logical group 1402 can include an electrical component for receiving flow ID information 1404. Additionally, an electrical component for matching a flow ID of a data packet to an appropriate policy rules, such as charging rules/QoS rule 1406 can also be included within the grouping 1402. This facilitates the data packets to be transmitted in the correct QoS pipe. The logical grouping can also include an electrical transmitter component for sending the data packets in accordance with respective rules 1408. Additionally, system 1400 can include a memory 1410 that retains instructions for executing functions associated with electrical components 1404, 1406 and 1408. While shown as being external to memory 1410, it is to be understood that one or more of electrical components 1404, 1406 or 1408 can exist within memory 1410.

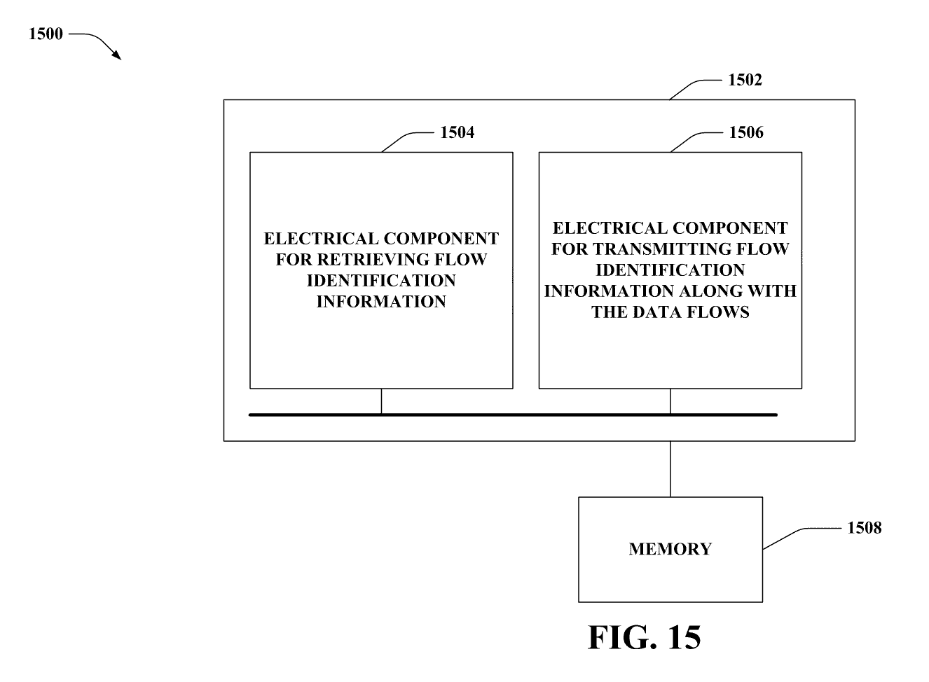

FIG. 15 is another example system 1500 that enables implementation of proper rules for various packet flows within a communication system. For example, system 1400 can reside within a network element. It is to be appreciated that system 1500 is represented as including functional blocks, which can be functional blocks that represent functions implemented by a processor, software, or combination thereof (e.g., firmware). System 1500 includes a logical grouping 1502 of electrical components that can act in conjunction. For example, logical group 1502 can include an electrical component 1504 for retrieving flow identification information for the received data flows. For example, the data flows can be received from a UE on the uplink and the electrical component 1504 can retrieve the flow identification information such as pointers, flow IDs or flow labels to be appended to an outer header of the data packets in accordance with an aspect. The data flows with the flow identification information appended therewith are then transmitted via the electrical component for transmitting the flow identification information along with the data flows 1506. This facilitates verification that the data flows were originally transmitted by a UE in accordance with the correct rules. Additionally, system 1500 can include a memory 15089 that retains instructions for executing functions associated with electrical components 1504, and 1506. While shown as being external to memory 1508, it is to be understood that one or more of electrical components 1504 or 1506 can exist within memory 1508.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method that facilitates tunneling in a wireless communication environment, comprising:
receiving one of one or more data flows or an indication that one or more data flows are to be received;
generating flow identification information for each of the one or more data flows; and
transmitting the flow identification information to a policy component to facilitate association of flow policies with the one or more data flows.

2. The method of claim 1, wherein transmitting the flow identification information further comprises transmitting one or more source addresses, DSCP or port numbers with the flow identification information.

3. The method of claim 2, further comprising combining at least a source address of at least one of the data flows with respective flow identification information to define a unique identifier for the at least one data flow.

4. The method of claim 1, wherein the flow policies include one or more of QoS rules, charging rules or PCC rules.

5. The method of claim 1, further comprising ciphering at least one of the one or more data flows.

6. The method of claim 4, wherein the at least one data flow is ciphered upon detecting an untrusted access.

7. The method of claim 1, further comprising receiving one or more other data flows with respective flow identification information.

8. The method of claim 7, further comprising verifying if the one or more other data flows were transmitted through an access mechanism in accordance with associated flow policies.

9. The method of claim 8, wherein the verification is based on comparing the flow identification information received within the one or more other data flows with the flow identification information associated with respective flow policies of the one or more other data flows.

10. The method of claim 1, further comprising representing the flow identification information as one or more of flow labels, flow IDs or pointers in an outer header of the one or more data flows.

11. A wireless communications apparatus, comprising:
a memory that retains instructions related to generating flow identification information for one or more data flows, and facilitating association of appropriate flow specific rules to the data flows by transmitting the generated flow identification information to a policy server; and
a processor, coupled to the memory, configured to execute the instructions retained in the memory.

12. The apparatus of claim 11, wherein the one or more data flows are encrypted.

13. The apparatus of claim 12, wherein the encryption is activated upon detection of a change in access mechanism from a trusted access to an untrusted access.

14. The apparatus of claim 11, wherein the flow identification information comprises one or more of flow labels, source addresses, DSCP or port numbers.

15. The apparatus of claim 14, wherein a source address is used in combination with the flow identification information represented as flow labels to uniquely identify at least one of the data flows.

16. The apparatus of claim 11, wherein the flow specific rules comprise one or more of QoS rules or charging rules.

17. A wireless communications apparatus that enables transmission of data flows in a wireless communication environment, comprising:
means for receiving one of one or more data flows or an indication of one or more data flows to be received;
means for generating flow identification information for each of the data flows such that appropriate flow specific rules can be associated with each of the data flows based at least on the generated flow identification information; and
means for transmitting the generated flow identification information.

18. The wireless communications apparatus of claim 17, wherein the data flows are encrypted.

19. The wireless communications apparatus of claim 17, wherein the data flows are encrypted when the means for receiving detects an untrusted access.

20. The wireless communications apparatus of claim 17, the means for transmitting the generated flow identification information also transmits a source address of the data flows in addition to the flow identification information to facilitate association of the flow specific rules with respective flows, wherein the flow specific rules comprise one or more of QoS rules or charging rules.

21. A computer program product, comprising:
a computer-readable medium comprising:
code for receiving one or more data flows;
code for generating flow identification information for each of the data flows; and
code for transmitting the generated flow identification information to a policy identifying component for association of appropriate flow specific rules with the data flows.

22. The computer program product of claim 21, wherein the computer-readable medium further comprises code for transmitting a source address in addition to the flow identification information represented as flow labels for association of the appropriate flow specific rules with the data flows.

23. The computer program product of claim 21, wherein the computer-readable medium further comprises code for detecting encryption associated with the data flows.

24. The computer program product of claim 21, wherein the computer-readable medium further comprises code for transmitting one or more tuples of IPv6 fields as the flow identification information for the association of appropriate flow specific rules, wherein the flow specific rules comprise one or more of QoS rules or charging rules.

25. A wireless communications apparatus, comprising:
a processor configured to:
receive one of one or more data flows or indication that one or more data flows are to be received;
generate flow identification information for each of the data flows; and
facilitate association of appropriate flow policies to the data flows by transmitting the generated flow identification information to a policy determining function.

26. The wireless communications apparatus of claim 25, wherein the processor is further configured to employ one or more of a source address or information from a tuple of IPv6 fields comprising DSCP or transport layer port numbers in addition to the flow identification information for association of the flow policies.

27. The wireless communications apparatus of claim 25, wherein the processor is further configured to detect an untrusted access mechanism in order to generate the flow identification information.

28. A method that facilitates tunneling in a wireless communication environment, comprising:
identifying one or more data flows;
retrieving respective flow identification information associated with each of the data flows;
identifying one or more rules to be implemented with the data flows; and
transmitting the data flows in accordance with the identified rules.

29. The method of claim 28, further comprising, transmitting the flow identification information along with respective data flows.

30. The method of claim 28, wherein the rules comprise one or more of charging rules or QoS rules.

31. The method of claim 28, wherein transmitting the data flows further comprises transmitting the data flows in appropriate QoS pipes based on the rules.

32. The method of claim 28, further comprising transmitting the retrieved flow identification information along with respective data flows.

33. A wireless communications apparatus, comprising:
a memory that retains instructions related to identifying flow identification information associated with one or more data flows, identifying one or more policy rules to be implemented with the data flows and transmitting the data flows in accordance with respective policy rules; and
a processor, coupled to the memory, configured to execute the instructions retained in the memory.

34. The wireless communications apparatus of claim 33, wherein the generated data flows are encrypted.

35. The wireless communications apparatus of claim 33, wherein the flow identification information comprises one or more of source addresses, DSCP or port numbers.

36. The wireless communications apparatus of claim 33, wherein the policy rules comprise one or more of charging rules or QoS rules.

37. A wireless communications apparatus that enables tunneling of data flows in a wireless communication environment, comprising:
means for receiving flow ID information;
means for matching the flow ID information of a data packet to appropriate policy rules; and
means for transmitting the data packets in accordance with respective policy rules.

38. The wireless communications apparatus of claim 37, further comprising means for generating the data packets.

39. A computer program product, comprising:
a computer-readable medium comprising:
code for identifying one or more data flows;
code for identifying flow identifying information associated with the data flows;
code for identifying one or more policy rules to be implemented with the data flows; and
code for transmitting the data flows in accordance with associated policy rules.

40. A wireless communications apparatus, comprising:
a processor configured for:
identifying one or more data flows;
retrieving flow identification information associated with the data flows;
identifying one or more policy rules to be implemented with the data flows; and
transmitting the data flows in accordance with the policy rules.

41. A method that facilitates tunneling in a wireless communication environment, comprising:
receiving an indication of one or more data flows;
receiving flow identification information for each of the one or more data flows;
determining flow specific rules to be implemented for each of the data flows; and
transmitting the flow identification information and the determined flow specific rules to facilitate communication of the one or more data flows in accordance with the determined flow specific rules.

42. The method of claim 41, further comprising receiving one or more source addresses of the data flows to facilitate determination of the flow specific rules to be implemented with the data flows.

43. The method of claim 41, further determining the flow specific rules based on existing rule sets comprising one or more of QoS rules or charging rules.

44. The method of claim 41, further comprising dynamically determining the flow specific rules to be implemented for each of the data flows.

45. A wireless communications apparatus, comprising:
a memory that retains instructions related to receiving flow identification information for one or more data flows, and facilitating determination of appropriate flow specific policies of the data flows; and
a processor, coupled to the memory, configured to execute the instructions retained in the memory.

46. The wireless communications apparatus of claim 45, further comprising instructions for receiving one or more source addresses of the data flows to facilitate determination of the flow specific policies to be implemented with the data flows.

47. The wireless communications apparatus of claim 45, further comprising predetermined flow specific policy sets for selection to be implemented with the data flows, the selection being based at least on the received flow identification information.

48. The wireless communications apparatus of claim 45, further comprising instructions for dynamically determining the flow specific policies to be implemented for each of the data flows.

49. The wireless communication apparatus of claim 45, wherein the flow specific policies further comprise one or more of QoS policies or charging policies.

50. A wireless communications apparatus that enables tunneling of data flows in a wireless communication environment, comprising:
means for receiving an indication of one or more data flows and flow identification information for each of the one or more data flows;
means for determining flow specific rules to be implemented for each of the data flows; and
means for transmitting the flow identification information and the flow specific rules to facilitate transmission of the one or more data flows in accordance with the determined flow specific rules.

51. The wireless communications apparatus of claim 50, further comprising means for generating the data flows.

52. A computer program product, comprising:
a computer-readable medium comprising:
code for receiving an indication of one or more data flows and flow identification information for the one or more data flows;
code for determining flow specific rules to be implemented for each of the data flows; and
code for transmitting the flow identification information and the flow specific rules to facilitate transmission of the one or more data flows in accordance with the determined flow specific rules.

53. A wireless communications apparatus, comprising:
a processor configured to:
receive an indication of one or more data flows and flow identification information for each of the one or more data flows;
determine flow specific rules to be implemented for each of the data flows; and
transmit the flow identification information with the flow specific rules to facilitate transmission of the one or more data flows in accordance with the determined flow specific rules.

54. The wireless communication apparatus of claim 53, wherein the flow identification information comprises one or more of flow labels, pointers, source addresses, DSCP or port numbers.

55. The wireless communication apparatus of claim 53, wherein the flow specific rules comprise one or more of charging rules or QoS rules.

56. A method that facilitates tunneling in a wireless communication environment, comprising:
receiving one or more data flows transmitted in accordance with specific rules;
receiving flow identification information associated with the specific rules; and
transmitting the flow identification information along with the received data flows for verification that the received data flows were transmitted in accordance with the specific rules

57. The method of claim 56, wherein the flow identification information comprises one or more of source addresses, DSCP or port numbers.

58. The method of claim 56, wherein the one or more received data flows are encrypted.

59. The method of claim 56, wherein the specific rules comprise one or more of charging rules of QoS rules.

60. A wireless communications apparatus, comprising:
a memory that retains instructions related to receiving one or more data flows transmitted in accordance with specific rules, retrieving flow identification information associated with the specific rules and transmitting the flow identification information along with the received data flows to facilitate verification of the specific rules; and
a processor, coupled to the memory, configured to execute the instructions retained in the memory.

61. A wireless communications apparatus that enables tunneling of data flows in a wireless communication environment, comprising:
means for receiving one or more data flows transmitted in accordance with specific rules;
means for retrieving flow identification information associated with the specific rules; and
means for transmitting the flow identification information along with the received data flows to facilitate verification of the specific rules.

62. A computer program product, comprising:
a computer-readable medium comprising:
code for receiving one or more data flows transmitted in accordance with specific rules;
code for retrieving flow identification information associated with the specific rules; and
code for transmitting the flow identification information along with the received data flows to facilitate verification of the specific rules.

63. A wireless communications apparatus, comprising:
a processor configured to:
receive one or more data flows transmitted in accordance with specific rules;
retrieve flow identification information associated with the specific rules; and
transmit the flow identification information along with the received data flows to facilitate verification that the received data flows were transmitted in accordance with rules as determined by a policy component.
